(19) United States
(12) Patent Application Publication
(10) Pub. No.: US 2023/0177555 A1
(43) Pub. Date: Jun. 8, 2023

(54) SYSTEMS AND METHODS FOR ITEM OBTAINMENT VIA AUTOMATED DISCHARGE

(71) Applicant: Capital One Services, LLC, McLean, VA (US)

(72) Inventors: Christopher WALLACE, McLean, VA (US); Samuel SHARPE, Cambridge, MA (US); Galen RAFFERTY, Mahomet, VA (US); Austin WALTERS, Savoy, IL (US); Grant EDEN, Menlo Park, CA (US); Anh TRUONG, Champaign, IL (US); Jeremy GOODSITT, Champaign, IL (US)

(73) Assignee: Capital One Services, LLC, McLean, VA (US)

(21) Appl. No.: 17/457,675

(22) Filed: Dec. 6, 2021

(51) Int. Cl. G06Q 30/02

(52) U.S. Cl. CPC G06Q 30/0233

(57) ABSTRACT

A method for item obtainment via automated discharge includes: obtaining first data associated with a user profile of a user, the first data including information associated with one or more items selected by the user, via a graphical interface operating on a user device associated with the user; monitoring user activity of the user profile, the user activity including one or more of obtainment interactions made by the user indicated by interaction data associated with the user profile, a value amount accumulated by the user profile, or a discharge schedule; based on the monitoring of the user activity, determining whether one or more criteria for automated discharge are satisfied for at least one of the one or more items of the first data; and in response to the one or more criteria being satisfied for at least one item, performing a discharge action for the at least one item.

### TECHNICAL FIELD

Various embodiments of the present disclosure relate generally to systems and methods for at least partially automated item obtainment via automated discharge, and, more particularly, to systems and methods for item obtainment using accumulated value via automated discharge.

### BACKGROUND

Many entities offer various types of incentive programs that enable a user to, for example, accumulate value for items obtained by the user from the entity, e.g., points, a partial credit, or the like. However, it may be difficult for a user to track or recall what or what quantity of benefits such as the foregoing they may have accumulated. For example, benefits may accrue for a user that are spread out over many different entities, or that, individually, may not be a significant value to the user. Additionally, when benefits are relatively small in value individually, it may be difficult for a user to appreciate the advantage of such benefits, and as a result, the benefits may have a decreased effectiveness as an incentive to obtain items from the entity. As a result, in some instances, benefits to users may remain unused and/or forgotten. Further, in some cases, a user may desire to obtain an item using one or more accrued benefits, but may not remember or have convenient access to such benefits at the time of obtainment. This may result in, for example, the user not obtaining the desired item or obtaining the item without the advantage of the accrued benefit(s).

The present disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for item obtainment via automated discharge.

An entity may desire to reward users by allowing them to accumulate value, for example, for using the entity’s services or items. However, for the user, this accumulated value may be partially or completely unused.

As will be discussed in more detail below, in various embodiments, systems and methods for item obtainment using accumulated value via automated discharge are described. By monitoring user activity to determine when certain criteria have been satisfied, users can have desired items automatically obtained using accumulated value.

In one aspect, an exemplary embodiment of a computer-implemented method for item obtainment via automated discharge may include: obtaining first data associated with a user profile of a user, the first data including information associated with one or more items selected by the user, via an interactive graphical interface operating on a user device associated with the user, for obtainment via automated discharge; monitoring user activity of the user profile, the user activity to be monitored including one or more of obtainment interactions made by the user indicated by interaction data associated with the user profile, a value amount accumulated by the user profile, or a discharge schedule associated with the user profile; based on the monitoring of the user activity, determining whether one or more criteria for automated discharge are satisfied for at least one of the one or more items of the first data; and in response to the one or more criteria being satisfied for at least one item, performing a discharge action for the at least one item.

In another aspect, a system for item obtainment via automated discharge may include: at least one memory storing instructions; and at least one processor operatively connected to the memory and configured to execute the instructions to perform operations. The operations may include: obtaining first data associated with a user profile of a user, the first data including information associated with one or more items selected by the user, via an interactive graphical interface operating on a user device associated with the user, for obtainment via automated discharge; monitoring user activity of the user profile, the user activity to be monitored including one or more of obtainment interactions made by the user indicated by interaction data associated with the user profile, a value amount accumulated by the user profile, or a discharge schedule associated with the user profile; based on the monitoring of the user activity, determining whether one or more criteria for automated discharge are satisfied for at least one of the one or more items of the first data; and in response to the one or more criteria being satisfied for at least one item, performing a discharge action for the at least one item.

In a further aspect, an exemplary embodiment of a computer-implemented method for item obtainment via automated discharge may include: obtaining first data associated with a user profile of a user, the first data including information associated with one or more items selected by the user, via an interactive graphical interface operating on a user device associated with the user, for obtainment via automated discharge; monitoring user activity of the user profile, the user activity to be monitored including one or more of obtainment interactions made by the user indicated by interaction data associated with the user profile, a value amount accumulated by the user profile, or a discharge schedule associated with the user profile; based on the monitoring of the user activity, determining whether one or more criteria for automated discharge are satisfied for at least one of the one or more items of the first data; in response to the one or more criteria being satisfied for at least one item: identifying at least one entity that provides the at least one item, and determining a value of the at least one item at the at least one entity; and causing the interactive graphical interface to display a selectable prompt for confirmation of performance of an automated discharge to obtain the at least one item; receiving a selection of the selectable prompt by the user, via the interactive graphical interface; and in response to receiving the selection of the selectable prompt, performing a discharge action for the at least one item that includes: executing an obtainment of the at least one item via the identified at least one entity; and deducting the value of the at least one item from the value amount accumulated by the user profile.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary computing environment for item obtainment via automated discharge, according to one or more embodiments.

FIG. 2 depicts a flowchart of an exemplary method for item obtainment via automated discharge, according to one or more embodiments.

FIG. 3 depicts a flowchart of an exemplary method for displaying progress toward one or more criteria, according to one or more embodiments.

FIG. 4 depicts a flowchart of an exemplary method for displaying progress toward one or more criteria, according to one or more embodiments.

FIG. 5 depicts a flowchart of an exemplary method for applying a portion of the accumulated value amount for an obtainment interaction, according to one or more embodiments.

FIG. 6 depicts a flowchart of an exemplary method for performing a discharge action, according to one or more embodiments.

FIG. 7 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “entity” generally encompasses an organization or person, e.g., that may be involved in providing a good, service, information, interaction, or the like. Terms like “item” or “product” generally encompasses a good, service, resource, benefit, information, or the like that may be transferred, shared, conveyed, or provided. Terms such as “user,” “customer,” or the like may be used interchangeably, and generally encompasses a person using a device in order to view, obtain, and/or interact with a product offered by an entity. The term “data” generally encompasses any type of information that may be stored in an electronic medium, such as personally identifying information, user preferences, customer history information, media, financial information, or the like.

In an exemplary use case, a user may desire to obtain one or more items via an interaction that takes advantage of one or more benefits, e.g., rather than via a customary transaction without such benefits. The user may add the one or more items to a list stored with a user profile associated with the user. For example, the user may search for and/or select one or more items to add to the list via an interactive interface of an electronic application operating on a user device associated with the user. In another example, the user may access, e.g., via a browser operating on the user device, an online resource of an entity offering the one or more items. An electronic application, e.g., a browser extension or the like that may operate in conjunction with the browser, may cause the online resource to display a selectable item as an alternative to a customary interaction with the entity. For instance, the selectable item may enable the user to cause the browser extension to add the one or more items to the list rather than, e.g., add the one or more items to an electronic cache for completing an interaction with the entity. In a further example, a first electronic application may interact with a second electronic application and/or an online resource of an entity, or the like, in order to retrieve one or more records associated with the user in order to obtain information regarding one or more items to add to the list.

In an exemplary use case, the electronic application may track user activity, e.g., as associated with the user profile. Such activity may include, for example, items obtained by the user, a value amount or other benefits accumulated by the user, e.g., via obtaining various items or completing interactions with one or more entities, location information of the user, or any other suitable information. The interface of the electronic application may, for example, enable a user to modify the one or more items on the list, adjust user preferences for the accumulation of value or other benefits with regard to the one or more items on the list, estimate, predict, or track a progress for the user profile accumulating sufficient value or other benefits to obtain the one or more items, or the like. User preferences may include, for example, how value or other benefits from an interaction with an entity may be allocated toward or distributed amongst the one or more items on the list, a priority order for the one or more items on the list, whether the one or more items are removed from, moved within, or maintained on the list after being obtained, a frequency and/or triggering criteria or events for obtaining the one or more items, or the like.

In an exemplary use case, the electronic application may be configured to automatically perform a discharge action, e.g., in response to the user profile satisfying one or more criteria. The criteria may include, for example, one or more of accumulation of value above a predetermined threshold, accumulation of value of at least a value of one of the one or more items, a predetermined frequency for obtaining items, a user request, or the like. The discharge action may include, for example, one or more of, notifying the user, e.g., via a notification displayed on the interface or an electronic message or the like, that at least one of the one or more items may be obtained via accumulated value or other benefits, via a selectable confirmation that, if selected, is configured to cause the electronic application to proceed with obtaining the at least one of the one or more items, or automatically obtaining the at least one of the one or more items.

In an exemplary use case, the monitoring of the user activity may indicate that the user has obtained an item on the list, e.g., via a customary interaction without the advantage of the accumulated value or other benefits. Such indication may be used by the electronic application as a criterion for a discharge action. The discharge action, e.g., for such an instance and/or in other various embodiments, may include canceling out at least a portion of a value of the at least one item from the obtainment interaction, e.g., in a statement or the like associated with a user account of the user, and deducting the at least portion of the value from the value amount accumulated by the user profile.

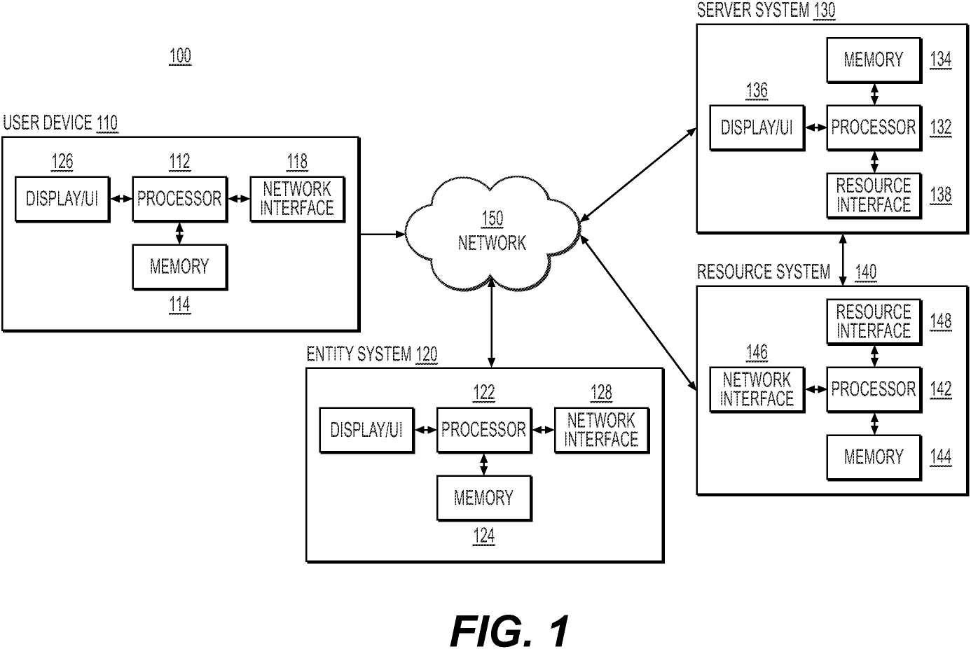

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

FIG. 1 depicts an exemplary computing environment 100 that may be utilized with techniques presented herein. One or more user device(s) 110, one or more entity system(s) 120, one or more server system(s) 130, and one or more resource system(s) 140 may communicate across a network 150 to carry out the methods and method steps as disclosed. The one or more user device(s) 110 may be associated with a user, e.g., a user that desires to automatically obtaining a desired item. The entity system 120 may be associated with an entity that provides one or more desired items, the server system 130 may be associated with the entity that provides the accumulated value or other benefit, and the resource system 140 may be, for example, a database or other repository of data that can be used e.g., in performing the methods and method steps disclosed as well as other activities. For example, the resource system 140 may include a system for processing interactions, e.g., between the user and the entity, such as when the user obtains an item from the entity whereby the resource system 140 may process a transfer of value from the user to the entity. The systems and devices of the computing environment 100 may communicate in any arrangement. As will be discussed herein, systems and/or devices of the computing environment 100 may communicate in order to automatically obtain an item for a user via automated discharge, as well as other activities.

The user device 110 may be configured to enable the user to access and/or interact with other systems in the computing environment 100. For example, the user device 110 may be a computer system such as, for example, a desktop computer, a mobile device, etc. In some embodiments, the user device 110 may include a processor 112 configured to execute one or more electronic application(s), e.g., a program, plugin, browser extension, etc., installed on a memory 114 of the user device 110. Users may interact with processor 112 via a display and/or user interface (Ul) 116, and user device 110 may access network 150 via network interface 118. In some embodiments, the electronic application(s) may be associated with one or more of the other components in the computing environment 100. For example, the electronic application(s) may enable the user, via the Ul for example, to access an item obtainment page associated with an entity and/or, as discussed in further detail below, a user profile of the user associated with the electronic application, e.g., that may be implemented and/or hosted at least in part by the server system 130. The server system 130 and/or the entity system 120 may interact with, for example, the resource system 140, e.g., in order to provide, process, and/or obtain interaction information associated with the user and the entity, as discussed in further detail below.

In various embodiments, the network 150 may be a wide area network (“WAN”), a local area network (“LAN”), personal area network (“PAN”), or the like. In some embodiments, network 150 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system, e.g., the resource system 140, so as to be accessible online, and that may include data configured to cause a program such as a web browser to perform operations such as send, receive, or process data, generate a visual display and/or an interactive interface, or the like.

The entity system 120 may be, for example, a server or other system associated with an institution that provides items. Entity system 120 may include a processor 122 to execute instructions stored in a memory 124 in order to allow entity system 120 to provide items in response to obtainment requests received via a display/UI 126 and/or a network interface 128.

Server system 130 may be, for example, a server or other system associated with an institution that rewards users with accumulated value, tracks the accumulation of such value for users, performs discharge actions, or other activities. Server system 130 may include a processor 132 to execute instructions stored in a memory 134 in order to allow server system 130 to retrieve user profiles, monitor user activity, and perform discharge actions in response to data received via a network interface 136 and/or a resource interface 138.

In some embodiments, server system 130 is configured to communicate with resource system 140 via network interface 136 and/or resource interface 138 to obtain data associated with a user or item. Resource system 140 may be, for example, a secure server or other system associated with an institution and on which data related to user activity and/or items may be stored. Resource system 140 may include a processor 142 to execute instructions stored in a memory 144 in order to allow resource system 140 to receive and store encrypted data received via a network interface 146 and/or a resource interface 148.

Although depicted as separate components in FIG. 1, it should be understood that one or more components, in various embodiments, may be at least partially integrated into one or more other components. Further, in various embodiments, one or more components may be at least partially distributed across multiple components.

In the exemplary methods discussed below, certain operations may be discussed as being performed by a component, e.g., the server system 130. It should be understood that such discussion is illustrative, and that such operations may be performed, for example, by a processor of such component, or by multiple components, etc. Further, it should be understood that the methods below are exemplary only, and that in various embodiments, various operations may be added, omitted, modified, or rearranged in any suitable manner as would be understood by one of ordinary skill in the art.

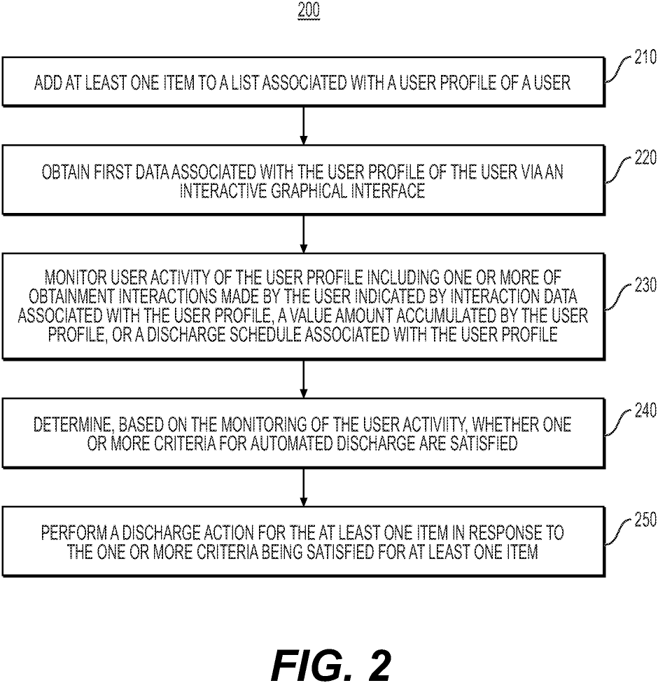

FIG. 2 illustrates an exemplary method 200 for item obtainment via automated discharge. In exemplary use example, a user, from time to time, may obtain one or more items from one or more entities. The user may be enrolled in one or more benefits programs, whereby value or other benefits may be allotted to the user for obtaining such items. The value or other benefits may be of any suitable form, e.g., points, a partial or percentage credit, a credit toward a particular item in a future interaction etc. Such value or other benefits may accrue, from time to time. A user profile associated with the user, e.g., that is executed by the server 130, may track the value or other benefits accrued by the user, such that a user profile associated with the user may accumulate such value or other benefits, e.g., over time. To promote the use of such accumulated value and/or benefits, the server system 130 may thus be configured to use such accumulated value and/or benefits to obtain one or more items on the user’s behalf via an automatic discharge action.

At step 210, the server system 130 may add at least one item to a list associated with a user profile of the user, e.g., an item to be obtained via an automatic discharge action. In some embodiments, the at least one item may be added to the list in response to user input. In various embodiments, such user input may be provided in a number of ways, for example, via an interaction with a graphical user interface on display/UI 116 of user device 110.

In some embodiments, the user input may be via an interaction with a selectable item inserted into a website page of an entity, e.g., via a browse extension associated with the server system 130. For example, the user may navigate, via a browser operating on user device 110, to a website page associated with an entity, e.g., a website page that includes a listing for at least one item and a selectable item associated with the entity that enables the user to obtain the at least one item and or add the at least one item to an electronic cache. The browser extension may insert the selectable item associated with the server system 130 into the website page for the at least one item, e.g., so that the user may choose to add the at least one item to the list instead of or in addition to directly obtaining the item from the entity.

In another embodiment, the at least one item may be added to the list via an at least partially automated process. For example, at regular intervals, in response to a user request, or the like, the server system 130 and/or the electronic application may obtain historical information associated with the user, e.g., a wish list or obtainment list associated with the user and stored on the entity system 120, resource system 140, or the like.

In another example, the server system 130 and/or electronic application may interact, e.g., via an Application Programming Interface (API) with a further electronic application, e.g., an obtainment assistance application, obtainment offer aggregation application, a universal item electronic cache, or the like, to obtain information regarding one or more items desired to be obtained by the user. It should be understood that one or more items may be added to the list, from time to time, by any suitable technique.

At step 220, the server system 130 may obtain first data associated with a user, such as a user profile, that includes information associated with one or more items desired by the user, e.g., the one or more items added to the list. In some embodiments, the first data may further include one or more criteria associated with the one or more items on the list. Criteria for an item may include, for example, a discharge amount to obtain the item, priority data for the item, e.g., relative to other items on the list, an amount of time since a previous discharge action of the item or another item before the item may be automatically obtained. In some embodiments, the first data may further include one or more user preferences. A user preference may include, for example, how value accumulated by the user profile is allocated to the item(s) in the list, how often or the criteria for triggering an automatic obtainment, whether an item is removed from the list or re-prioritized after being obtained, etc. In some embodiments, the first data may further include instructions for performing one or more discharge actions and/or post-discharge actions, e.g., for each of the one or more items.

At step 230, the server system 130 may monitor activity associated with the user. In some embodiments, the server 130 may be configured to aggregate user activity data via the use profile. In some embodiments, the server system 130 may be configured to obtain user activity data from another system, e.g., the resource system 140, entity system 120, or user device 110. Activity to be monitored may include, for example, obtainment interactions made by the user, a value amount accumulated by the user profile, or a discharge schedule associated with the user profile. The discharge schedule may include, for example, a frequency for performing a discharge action of a particular item and/or of the one or more items on the list. Monitoring such discharge schedule may include, for example, determining whether a period of time since a last discharge action correspond to the frequency has elapsed.

Based on the monitoring of the user activity, at step 240, the server system 130 may determine whether one or more criteria for an automated discharge, e.g., such as the criteria discussed in the examples and discussion above, have been satisfied for one or more of the items identified in the obtained data from step 210.

In the event that one or more of the criteria are satisfied, at step 250, the server system may perform one or more discharge actions for one or more of the items desired by the user. In some embodiments, the server system 130 may be configured to, for example, only consider a next-highest priority item in the list for obtainment. In an illustrative example, a list of a user profile may have a first item with an obtainment value of $5.00 and a second item with an obtainment value of $10. The first item may have a low priority, and the second item may have a high priority. The first data may include a user preference to attempt to perform a discharge action once per month. At the end of a one-month interval, the user profile may have accumulated $7.00 or an equivalent in value. The server system 130 may determine that the second item is higher priority, and that the accumulated value of $7.00 is insufficient to obtain the second item. Even though the first item could be obtained, the server system 130 may not perform any discharge action because the higher priority second item has not yet been obtained. In various embodiments, any arrangement for criteria for performing discharge actions may be used. For example, in some embodiments, priority for items may be applied in conjunction with one or more of: a frequency for obtainment of a particular item, frequency for obtainment of any item, different threshold for different items (e.g., if the accumulated value in the user profile is above X but below Y, obtain item 1, if above Y, item 2, etc.), or the like. In some embodiments, the one or more criteria may be applied via an order of operations, e.g., as set by the user.

The discharge action performed by the server system 130 may include, for example, identifying at least one entity that provides the at least one item and determining a value of the at least one item at the at least one entity. In some embodiments, the server system 130 may obtain information such as the forgoing from another system, e.g., the resource system 140, the entity system 120, or the like. In some embodiments, the server system 130 may use an API to, for example, request such information from another electronic application, e.g., an electronic application configured to find offers for identified items.

The discharge action may include causing the interactive graphical interface of the user device 110 to display a selectable prompt for confirmation of performance of an automated discharge to obtain the at least one item. In some embodiments, the selectable prompt may be in the form of a notification (e.g., a push notification), an SMS message, an electronic mail message, a website page, a pop-up, or any suitable type of interactive element. In response to receiving an indication, e.g., via the user device 110, that the user has selected the selectable prompt, the server system 130 may be configured to perform a further discharge action, such as the identifying above, or the automatic obtainment below. In some embodiments, the display of the selectable prompt is performed after the identifying discharge action, and the selectable prompt may include the obtained information, e.g., the obtainment value of the item and/or the entity offering the item.

The discharge action may include executing an obtainment of the at least one item, e.g., by initiating an automatic obtainment interaction via the identified at least one entity.

The discharge action may include deducting the obtainment value of the at least one item from the value amount accumulated by the user profile. In other words, from the perspective of the user, the at least one item may be obtained via the value or other benefits accumulated via the user profile, e.g., instead of value directly from the user, e.g., a user account.

As noted above, the monitoring may include monitoring the user activity to identify whether the user performs an obtainment interaction for an item on the list, e.g., despite the item being on the list for obtainment via a discharge action. Such an interaction by the user may prevent the accumulated value or benefits from being used to obtain the item. In some embodiments, the discharge action may include removing the obtained item from the list, e.g., without deducting any of the accumulated value from the user profile.

However, it may be beneficial for the user to be able to benefit from accumulated value or benefits when obtaining an item from an entity. In some embodiments, the discharge action may include, e.g., in instances where such an obtainment interaction by the user for at least one item on the list is identified via the monitoring, cancelling out at least a portion of a value of the at least one item from the obtainment interaction. For example, the resource system 140 may, e.g., periodically, provide the user with a statement indicating a balance to be remitted to account for obtainment interactions performed by the user. The server system 130 may, for example, obtain such information, determine an interaction that is associated with the obtainment of at least one item on the list, and cancel, deduct, credit, or the like a portion of the value for that interaction corresponding to the obtainment value of the at least one item. In an exemplary embodiment, the server system 130 may determine that an interaction is associated with obtainment of at least one item on the list by, for example, obtaining and then comparing historical information of interactions of the user from the entity system 120 with the information in the statement obtained from the resource system 140. Any suitable technique for identifying an associated interaction may be used. For example, the user may have used an electronic application associated with the server system 130 to perform the interaction, and information regarding the information may thus be obtained from the server system 130 itself.

In some embodiments, after performing one or more discharge action, the server 130 may perform at least one post discharge action, e.g., based on a user preference or instruction in the first data. The post discharge action may include one or more of removing the at least one item from the first data; modifying a priority ranking of the at least one item in the first data (e.g., lowering a priority of the at least one item relative to at least one other item in the list); or adding or modifying a criterion for the at least one item. For instance, the server 130 may generate or modify a criterion for an item so that the item may not be obtained by the server 130 until a predetermined amount of time after the performing of the one or more discharge actions for the at least one item has transpired.

As noted above, in some instances, under-utilization of accumulated value or other benefits may result, at least in part, from a difficulty of tracking and/or being aware of such value, and/or in a difficulty in seeing small individual accumulations of value as significant. Thus, techniques for tracking accumulation of value, as well as illustrating how such accumulation may relate to item obtainment, may be beneficial.

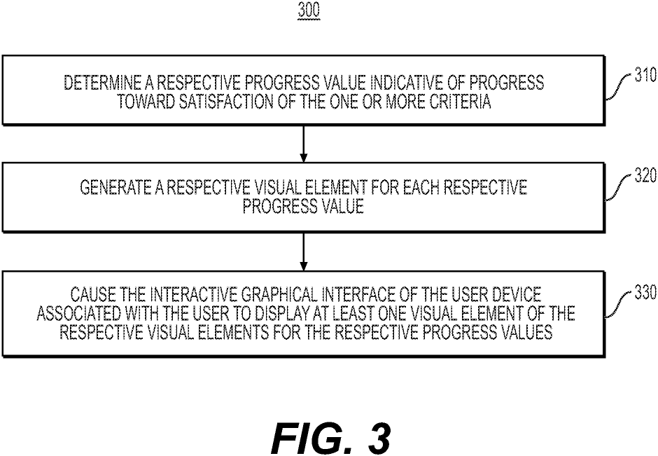

FIG. 3 illustrates an exemplary method 300 for displaying progress toward one or more criteria, e.g., progress toward the obtainment of the one or more items on the list. The user may navigate to a website page or access an electronic application associated with the server system 130 in order to access information related to the user profile, e.g., in the form of a dashboard. At step 310, the server system 130 may determine a respective progress value indicative of progress toward satisfaction of the one or more criteria.

Although discussed above with regard to a website page associated with the user profile, it should be understood that, in various embodiments, the respective progress value, may be determined in a manner unassociated with the website page, e.g., periodically, and/or in response to a detected change in the user profile. In other words, the respective progress value may be determined with or without the user visiting the website page associated with the user profile.

In some embodiments, the progress value may be associated with the accumulated value associated with the user profile and/or for at least one item on the list in particular relative to the obtainment value for the at least one item. For example, a user preference may include an instruction for how accumulated value is distributed across items on the list. For instance, the user preference may indicate that each instance of accumulated value is evenly distributed across the items in the list, may indicate that predetermined amounts or percentages of each instance of accumulated value are distributed to different items, that higher priority items are distributed accumulated value prior to lower priority items, etc. The progress value may indicate, for example, how much accumulated value of the user profile has been allocated to each item, how much value remains before the obtainment value of an item has been allocated, how much value has been accumulated by the user profile as a whole, how much additional value is to be accumulated before an item may be obtained, etc.

At step 320, the server system 130 may generate a respective visual element for each of the respective progress values determined at step 310. The progress value may be represented as, for example, one or more of a number, a percentage, a fraction, a progress bar, or the like on the interactive graphical interface.

At step 330, the server system 130 may cause the interactive graphical interface of the user device associated with the user to display at least one visual element of the respective visual elements for the respective progress values. In some embodiments, instead of or in addition to the foregoing, the server system 130 may transmit a notification to the user device 110 that includes the respective visual element for one or more of the items on the list. The notification may include, for example, an SMS message, a push notification, an electronic mail message, or the like. In some embodiments, the server system 130 may be configured to transmit such a notification in response to one or more criteria being satisfied. For example, a notification may be triggered in response to a progress value reaching a predetermined threshold, e.g., a percentage toward an item being able to be obtained, a threshold amount of value remaining to be accumulated before the item is able to be obtained, etc. In some embodiments, the notification may include information associated with the criteria for performing a discharge action for the item which, in some embodiments, may be similar to the criteria for the notification discussed above.

As noted above, in some instances, such as when the value accumulated for an individual interaction is relatively small, it may be difficult for a user to appreciate how such accumulated value or benefits may be advantageous. Thus, it may be beneficial to illustrate to the user when the user may expect the one or more items on the list to be obtained.

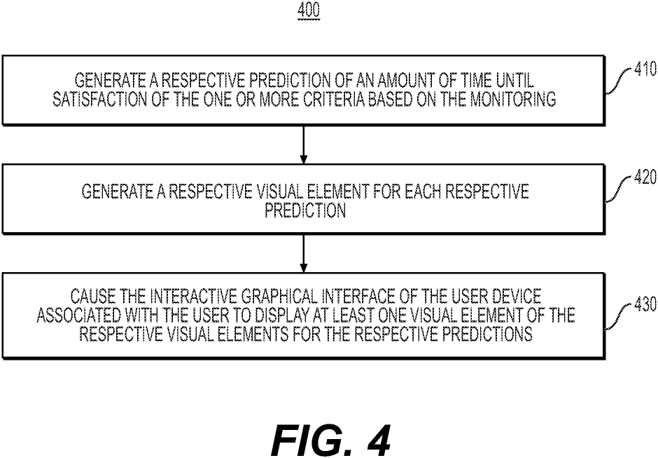

FIG. 4 depicts an additional embodiment of a method 400 for displaying progress toward one or more criteria. At step 410, the server system 130 may generate a respective prediction of an amount of time until satisfaction of the one or more criteria based on the monitoring. Any suitable technique for generating such a prediction may be used. In an exemplary embodiment, the server 130 may obtain historical interaction information associated with the user, and based on such information, may determine, for example, an average rate at which value or other benefits are accumulated for the user profile associated with the user. In some embodiments, the server system 130 may be configured to determine one or more patterns in the historical information, e.g., increased quantity or value of interactions by the user near an event or holiday or during a particular season, whereby the prediction of the rate may be based on such identified pattern(s).

As noted above, the user may navigate to a dashboard associated to the user profile. At step 420, the server system 130 may generate a respective visual element for each respective prediction determined at step 410. Such visual elements may include, for example, a text or numerical notification indicating an estimated time until obtainment (an “ETA”), or any other suitable type of visual indication.

At step 430, the server system 130 may cause the interactive graphical interface of the user device associated with the user to display at least one visual element of the respective visual elements for the respective predictions. In some embodiments, instead of or in addition to the foregoing, the at least one visual element for the ETA may be included in a notification similar to (or combined with) the notification above with regard to the progress value.

In some embodiments, the server system 130 may be configured to display one or more of the first data (e.g., the list of items) as a visual representation, in conjunction with one or more of the visual elements for the predictions determined at steps 410 or 310, e.g., as a dashboard associated with the user profile. In some embodiments, the dashboard may include one or more interactive elements that enable the user to, for example, add, edit, or remove items from the list, modify user preferences, or the like. It should be understood that the dashboard is an illustrative example of displaying the first data and/or visual elements, and that any suitable technique for displaying the first data and/or the visual elements may be used, e.g., a website page, a pop-up window, or the like.

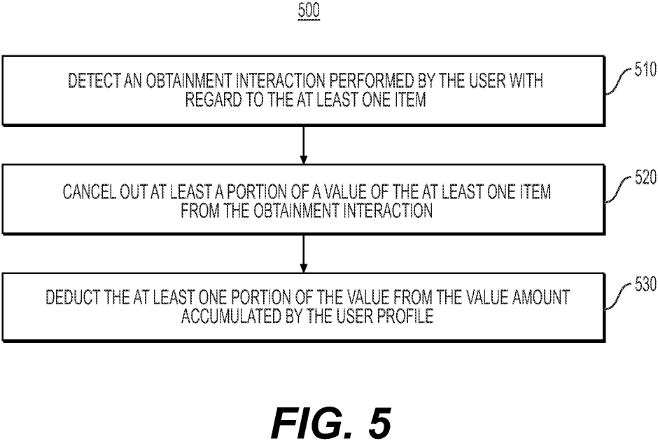

As noted above, in some situations, the user may obtain one or more of the items on the list associated with the user profile other than by automatic discharge, e.g., by initiating an interaction with an entity offering the item. FIG. 5 illustrates an exemplary method 500 for applying a portion of the accumulated value amount for an obtainment interaction conducted by the user. At step 510, the server system 130 may detect an obtainment interaction performed by the user with regard to the at least one item, e.g., such as via the techniques discussed in one or more of the examples discussed above. At step 520, the server system 130 may cancel out at least a portion of a value of the at least one item from the obtainment interaction. At step 530, the server system 130 may deduct the at least portion of the value from the value amount accumulated by the user profile.

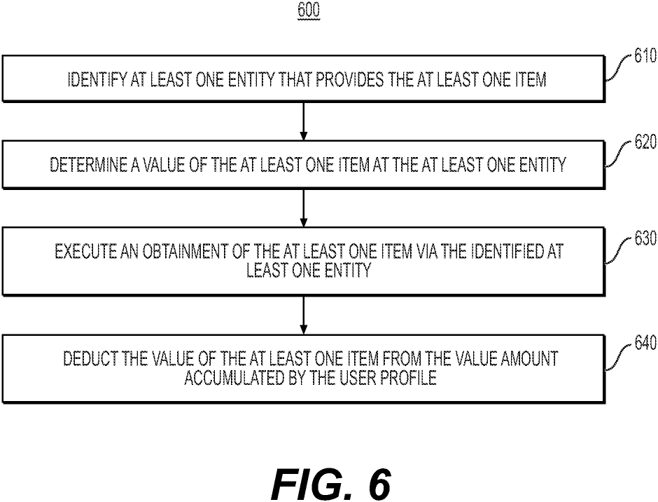

Having determined that criteria for an automated discharge have been satisfied, FIG. 6 depicts an exemplary method 600 for performing an appropriate discharge action. At step 610, the server system 130 may identify at least one entity that provides the at least one item. At step 620, the server system 130 may determine a value of the at least one item at the at least one entity. At step 630, the server system 130 may execute an obtainment of the at least one item via the identified at least one entity. At step 640, the server system 130 may deduct the value of the at least one item from the value amount accumulated by the user profile. In some embodiments, the server system 130 may generate and/or modify a notification to the user device 110 to include information associated with the execution of the obtainment of the at least one item.

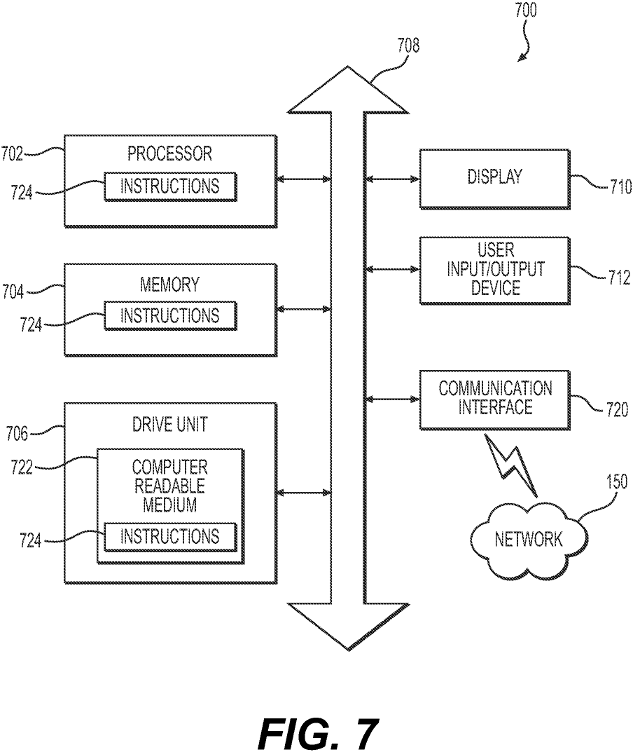

FIG. 7 is a simplified functional block diagram of a computer 700 that may be configured as a device for executing the methods of FIGS. 2-6, according to exemplary embodiments of the present disclosure. For example, the computer 700 may be configured as server system 130 and/or another system according to exemplary embodiments of the present disclosure. In various embodiments, any of the systems herein may be a computer 700 including, for example, a data communication interface 720 for packet data communication. The computer 700 also may include a central processing unit (“CPU”) 702, in the form of one or more processors, for executing program instructions. The computer 700 may include an internal communication bus 708, and a storage unit 706 (such as ROM, HDD, SDD, etc.) that may store data on a computer readable medium 722, although the computer 700 may receive programming and data via network communications. The computer 700 may also have a memory 704 (such as RAM) storing instructions 724 for executing techniques presented herein, although the instructions 724 may be stored temporarily or permanently within other modules of computer 700 (e.g., processor 702 and/or computer readable medium 722). The computer 700 also may include input and output ports 712 and/or a display 710 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

1. A computer-implemented method for item obtainment via automated discharge, comprising:
obtaining first data associated with a user profile of a user, the first data including information associated with one or more items listed for obtainment via automated discharge, and one or more criteria for automated discharge of the one or more items, wherein the user profile is configured to track user activity including one or more of obtainment interactions made by the user, a reward value amount accumulated by the user profile, or an automated discharge schedule associated with the user profile;
monitoring the user activity via the user profile, wherein the monitoring includes:
accessing, on a memory of a system for storing obtainment transaction data, obtainment transaction data associated with the user; and
updating the reward value accumulated by the user profile based on the accessed obtainment transaction data, such that reward value amount is automatically updated as the user makes obtainment interactions:
based on the monitoring of the user activity, determining whether the one or more criteria for automated discharge is satisfied for at least one of the one or more items of the first data; and
in response to the one or more criteria being satisfied for at least one item, performing an automated discharge action for the at least one item using the reward value amount accumulated by the user profile.

2. The computer-implemented method of claim 1, further comprising:
determining a respective progress value indicative of progress toward satisfaction of the one or more criteria for each of the one or more items of the first data;
generating a respective visual element for each respective progress value; and
causing an interactive graphical interface of operating on a user device associated with the user to display at least one visual element of the respective visual elements for the respective progress values.

3. The computer-implemented method of claim 1, further comprising:
generating a respective prediction, based on the monitoring, of an amount of time until satisfaction of the one or more criteria for each of the one or more items of the first data;
generating a respective visual element for each respective prediction; and
causing an interactive graphical interface operating on a user device associated with the user to display at least one visual element of the respective visual elements for the respective predictions.

4. The computer-implemented method of claim 1, further comprising:
causing an interactive graphical interface operating on a user device associated with the user to display a visual representation of the first data and an interactive element operable by the user, via the user device, to modify the first data, wherein modifying the first data includes adding the one or more items to the first data.

5. The computer-implemented method of claim 1, wherein the one or more criteria include one or more of:
a discharge amount for each item;
an amount of time elapsed since execution of a previous discharge action; or
priority data for the one or more items of the first data.

6. The computer-implemented method of claim 1, further comprising:
in response to performing the automated discharge action for the at least one item, performing one or more automated post-discharge actions selected from:
removing the at least one item from the first data;
modifying a priority ranking of the at least one item in the first data; or
adding or modifying a criterion for the at least one item, in the first data, for a predetermined amount of time after the performing of the automated discharge action for the at least one item.

7. The computer-implemented method of claim 1, wherein the first data further includes instructions for performing one or more of automated discharge actions or automated post-discharge actions for each of the one or more items.

8. The computer-implemented method of claim 1, wherein:
the one or more criteria for the at least one item includes detecting, based on the monitoring, an obtainment interaction performed by the user with regard to the at least one item; and
the automated discharge action includes canceling out at least a portion of a value of the at least one item from the obtainment interaction and deducting the at least portion of the value from the reward value amount accumulated by the user profile.

9. The computer-implemented method of claim 1, wherein:
the automated discharge action includes identifying at least one entity that provides the at least one item, and determining a value of the at least one item at the at least one entity.

10. The computer-implemented method of claim 9, wherein:
the one or more criteria for the at least one item includes a criterion that the reward value amount accumulated by the user profile meets or exceeds a value of the at least one item; and
the automated discharge action further includes:
executing an obtainment of the at least one item via the identified at least one entity; and
deducting the value of the at least one item from the reward value amount accumulated by the user profile.

11. The computer-implemented method of claim 10, wherein:
the automated discharge action further includes causing an interactive graphical interface operating on a user device associated with the user to display a selectable prompt for confirmation of performance of an automated discharge to obtain the at least one item;
the computer-implemented method further includes receiving a selection of the selectable prompt by the user, via the interactive graphical interface; and
the executing of the obtainment and the deducting of the value of the at least one item is performed in response to receiving the selection of the selectable prompt.

12. The computer-implemented method of claim 1, wherein obtaining at least a portion of the first data is obtained by one or more of:
receiving a selection of at least one item by the user via an alternative obtainment interactive element displayed by an interactive graphical interface; or
retrieving information associated with at least one item from a further user profile associated with the user for an electronic item obtainment assistant application.

13. A system for item obtainment via automated discharge, comprising:
at least one memory storing instructions; and
at least one processor operatively connected to the at least one memory and configured to execute the instructions to perform operations, including:
obtaining first data associated with a user profile of a user via an interactive graphical interface operating on a user device associated with the user, wherein:
the first data includes information associated with one or more items selected by the user for obtainment via automated discharge and one or more criteria for automated discharge of the one or more items; and
the user profile is configured to track user activity including one or more of obtainment interactions made by the user, a reward value amount accumulated by the user profile, or an automated discharge schedule associated with the user profile
monitoring the user activity via the user profile, and based on the monitoring of the user activity, determining whether the one or more criteria for automated discharge is satisfied for at least one of the one or more items of the first data;
determining a respective progress value indicative of progress toward satisfaction of the one or more criteria for each of the one or more items of the first data;
generating a respective visual element for each respective progress value;
causing the interactive graphical interface of the user device associated with the user to display at least a portion of the respective visual elements for the respective progress values;
generating a respective prediction, based on the monitoring, of an amount of time until satisfaction of the one or more criteria for each of the one or more items of the first data;
generating a respective visual element for each respective prediction;
causing the interactive graphical interface of the user device associated with the user to display at least a portion the respective visual elements for the respective predictions;
determining, based on the monitoring, a change in the reward value accumulated by the user profile;
based on the change in the reward value, updating the respective progress values and the respective predictions, and causing the interactive graphical interface to update the display of the respective visual elements for the respective progress values and for the respective predictions, such that the display is automatically updated as the reward value changes; and
in response to the one or more criteria being satisfied for at least one item, performing an automated discharge action for the at least one item using the reward value amount accumulated by the user profile.

14. The system of claim 13, wherein the operations further include:
causing the interactive graphical interface of the user device associated with the user to display a visual representation of the first data and an interactive element operable by the user, via the user device, to modify the first data.

15. The system of claim 13, wherein the one or more criteria include one or more of:
a discharge amount for each item in the first data;
an amount of time elapsed since execution of a previous discharge action; or
priority data for the one or more items of the first data.

16. The system of claim 13, wherein the operations further include:
in response to performing the automated discharge action for the at least one item, performing one or more automated post-discharge action selected from:
removing the at least one item from the first data;
modifying a priority ranking of the at least one item from the first data; or
adding or modifying a criterion for the at least one item from the first data for a predetermined amount of time after the performing of the automated discharge action for the at least one item.

17. The system of claim 13, wherein the first data further includes instructions for performing one or more of automated discharge actions or automated post-discharge actions for each of the one or more items from the first data.

18. The system of claim 13, wherein:
the one or more criteria for the at least one item includes detecting, based on the monitoring, an obtainment interaction performed by the user with regard to the at least one item; and
the automated discharge action includes canceling out at least a portion of a value of the at least one item from the obtainment interaction and deducting the at least portion of the value from the reward value amount accumulated by the user profile.

19. The system of claim 13, wherein:
the automated discharge action includes identifying at least one entity that provides the at least one item, and determining a value of the at least one item at the at least one entity;
the one or more criteria for the at least one item includes a criterion that the reward value amount accumulated by the user profile meets or exceeds a value of the at least one item; and
the automated discharge action further includes:
executing an obtainment of the at least one item via the identified at least one entity; and
deducting the value of the at least one item from the reward value amount accumulated by the user profile.

20. A computer implemented method for item obtainment via automated discharge, comprising:
obtaining first data associated with a user profile of a user via an interactive graphical interface operating on a user device associated with the user, wherein:
the first data includes information associated with one or more items selected by the user for obtainment via automated discharge and one or more criteria for automated discharge of the one or more items; and
the user profile is configured to track user activity including one or more of obtainment interactions made by the user, a reward value amount accumulated by the user profile, or an automated discharge schedule associated with the user profile
monitoring the user activity via the user profile, and based on the monitoring of the user activity, determining whether the one or more criteria for automated discharge is satisfied for at least one of the one or more items of the first data, wherein the one or more criteria includes detecting, based on the monitoring data from a transaction system indicative of an obtainment interaction performed by the user with regard to the at least one item;
in response to the one or more criteria being satisfied for at least one item:
identifying at least one entity that provides the at least one item, and determining a value of the at least one item at the at least one entity; and
causing the interactive graphical interface to display a selectable prompt for confirmation of performance of an automated discharge to obtain the at least one item;
receiving a selection of the selectable prompt by the user, via the interactive graphical interface; and
in response to receiving the selection of the selectable prompt, performing an automated discharge action for the at least one item using the reward value amount accumulated by the user profile, wherein performing the automated discharge action includes:
canceling out at least a portion of a value of the at least one item from the obtainment interaction; and
deducting the value of the at least one item from the reward value amount accumulated by the user profile.
